(19) United States
(12) Patent Application Publication
(10) Pub. No.: US 2010/0321159 A1
(43) Pub. Date: Dec. 23, 2010

(54) TOUCH BASED DATA COMMUNICATION USING BIOMETRIC FINGER SENSOR AND ASSOCIATED METHODS

(75) Inventor: Arthur L. Stewart, Melbourne Beach, FL (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: AuthenTec, Inc., Melbourne, FL (US)

(21) Appl. No.: 12/816,795

(22) Filed: Jun. 16, 2010

Related U.S. Application Data
(60) Provisional application No. 61/218,133, filed on Jun. 18, 2009.

(51) Int. Cl. G05B 19/00

(52) U.S. Cl. 340/5.83

(57) ABSTRACT

A communications system may include a terminal device that may include a housing, and a conductive radio frequency (RF) terminal receiver carried by the housing for receiving an RF signal conducted via contact with a user. The communications system may also include a user device including a portable housing, and a finger sensor carried by the portable housing and that may include RF excitation circuitry for sensing a finger of the user, and for serving as a conductive RF user device transmitter to transmit the RF signal onto the user to be received by the conductive RF terminal receiver.

### RELATED APPLICATION

The present application is based upon previously filed copending provisional application Ser. No. 61/218,133, filed Jun. 18, 2009, the entire subject matter of which is incorporated by reference in its entirety.

### FIELD OF THE INVENTION

The present invention relates to the field of electronics, and, more particularly, to the field of finger sensors including finger sensing integrated circuits, and associated manufacturing methods.

### BACKGROUND OF THE INVENTION

It may be desirable to exchange data between two electronic devices, such as, a cellular telephone and a point of sale terminal (POS), for example. For example, payment approaches currently provide either a credit card swipe, a credit card tap using radio frequency identifiers (RFID), and conducted communications approaches that use the human body as a transmission medium. An RFID or near field transmitter may be included in a cellular telephone with a small cost impact to the phone, for example, four dollars per unit.

Along those lines, U.S. Patent Application Publication No. 2008/0046379 to Beenau et al. discloses a radio frequency identification based system that includes a FOB that is used to complete a transaction at a point of sale terminal. The FOB includes a fingerprint sensor or other biometric sensors for authorization of the transaction.

A transmitter may be worn on the body or in close proximity thereto to communicate data to a receiver upon contact with the body. For example, U.S. Pat. No. 7,082,316 to Eiden et al. discloses detecting a physical contact between users, where each user is touching an electrode on a mobile wireless communications device, and transferring data therebetween to form a group.

Applications using a human medium for data transmission include communicating business card information, or providing access through security doors, for example. NTT DoCoMo and Kaiser Technology, Inc. have developed a communications system, as disclosed in European Published Application No. EP 1,848,130, that allows data to be communicated from a mobile wireless communications device or transmitter that does not have to be in contact with the human body, but rather in close proximity to it. Still the human body is used as a medium to transmit data to a receiver. For example, business card information may be passed from the mobile wireless communications device to another person via a handshake, or a person may be granted access to a secured door with a touch of a finger.

In some systems, the data being transferred may include personal identification, for example, or data for authentication purposes. U.S. Pat. No. 6,580,356 to Alt et al. discloses a transmitter that is directly coupled to the body and transfers an electrical signal therethrough. A receiver may include a fingerprint sensor for a higher level of security in the data transaction. Still other biometrics may be used in human medium based communications systems to provide authentication.

U.S. Patent Application Publication No. 2003/0037264 to Ezaki et al. discloses a transmitter or authentication device being worn on a human body cooperating with a receiver to provide authentication processing with a machine, such as a personal computer. The authentication device reads biometrics information and detects a correlation between the read biometrics and stored biometrics of a user. Stored biometrics include blood vessel patterns. Authentication information is passed when the user touches a mouse that is connected to the personal computer.

While human medium communications systems, such as the DoCoMo system, for example, stress convenience and security, still, there is a need for added security to these systems.

### SUMMARY OF THE INVENTION

In view of the foregoing background, it is therefore an object of the present invention to provide a human medium communications system with increased security, convenience, and speed at a point of presence.

This and other objects, features, and advantages in accordance with the present invention are provided by a communications system that may include a terminal device that may include a housing, and a conductive radio frequency (RF) terminal receiver carried by the housing for receiving an RF signal conducted via contact with a user. The communications system may also include a user device that may include a portable housing, and a finger sensor carried by the portable housing. The finger sensor may include RF excitation circuitry for sensing a finger of the user, and for serving as a conductive RF user device transmitter to transmit the RF signal onto the user to be received by the conductive RF terminal receiver, for example. Accordingly, the communications system provides increased security in processing data transaction using a human medium.

The RF excitation circuitry may be for performing a user authentication function. The RF excitation circuitry may transmit the RF signal onto the human user based upon a successful user authentication, for example. Alternatively, or additionally, the RF excitation circuitry may be for performing a device navigation function.

The user device may further include a wireless transceiver carried by the portable housing, for example, a cellular transceiver. The RF excitation circuitry may also be for serving as a conductive RF user device receiver for receiving an RF signal from the user transmitted by the terminal device, for example. This advantageously may allow for two-way communication between the user device and the terminal device.

The finger sensor may include a drive electrode coupled to the RF excitation circuitry to transmit the RF signal onto the finger of the user. The terminal device may include a point-of-sale (POS) terminal device, for example.

A method aspect is directed to a communications method and may include transmitting an RF signal onto a human user using RF excitation circuitry of a user device for sensing a finger of the human user and for serving as a conductive RF transmitter. The method may also include receiving the RF signal from an RF receiver of a terminal device via contact with the human user, for example. Another method aspect is directed to a method of making the communications system. Yet another method aspect is directed to a method of using the user device.

### BRIEF DESCRIPTION OF THE DRAWINGS

FIG. 1 is a schematic plan view of a cellular telephone including a finger sensor in accordance with the invention.

FIG. 2 is an enlarged perspective view of a portion of the finger sensor shown in FIG. 1.

FIG. 3 is a plan view of a portion of the finger sensor as shown in FIG. 1 with alternative embodiments of connector portions being illustrated.

FIG. 4 is an enlarged schematic cross-sectional view through a portion of the finger sensor as shown in FIG. 1.

FIG. 5 is a plan view of a portion of a finger sensor in accordance with the invention, similar to FIG. 3, but showing a different embodiment of a connector portion.

FIG. 6 is a schematic cross-sectional view of a mounted finger sensor in accordance with the invention.

FIG. 7 is a schematic cross-sectional view of another embodiment of a mounted finger sensor in accordance with the invention.

FIG. 8 is a schematic cross-sectional view of yet another embodiment of a mounted finger sensor in accordance with the invention.

FIG. 9 is a schematic diagram illustrating some of the manufacturing steps for a finger sensor as shown in accordance with the invention.

FIG. 10 is a schematic diagram of a communications system in accordance with the invention.

FIG. 11 is a schematic cross-sectional view of a fingerprint sensor assembly of the communications system of FIG. 10.

### DETAILED DESCRIPTION OF THE PREFERRED EMBODIMENTS

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout and prime notation is used to indicate similar elements in alternative embodiments.

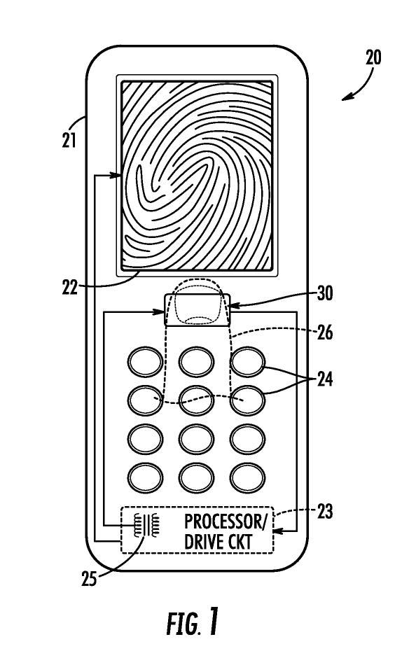

Referring initially to FIGS. 1-4, embodiments of a finger sensor 30 are now described. The finger sensor 30 is illustratively mounted on an exposed surface of a candy bar-type cellular telephone 20. The illustrated candy bar-type cellular telephone 20 is relatively compact and does not include a flip cover or other arrangement to protect the finger sensor 30 as may be done in other types of cellular telephones. Of course, the finger sensor 30 can also be used with these other more protective types of cellular telephones as will be appreciated by those skilled in the art. The finger sensor 30 can also be used with other portable and stationary electronic devices as well. The increased durability and ruggedness of the finger sensor 30 will permit its widespread use even when exposed.

The cellular telephone 20 includes a housing 21, a display 22 carried by the housing, and processor/drive circuitry 23 also carried by the housing and connected to the display and to the finger sensor 30. An array of input keys 24 are also illustrated provided and used for conventional cellular telephone dialing and other applications as will be appreciated by those skilled in the art. The processor/drive circuitry 23 also illustratively includes a micro step-up transformer 25 that may be used in certain embodiments to increase the drive voltage for the finger sensor 30 as explained in greater detail below.

The finger sensor 30 may be of the slide type where the user's finger 26 slides over the sensing area to generate a sequence of finger images. Alternatively, the finger sensor 30 could be of the static placement type, where the user simply places his finger 26 onto the sensing surface to generate a finger image. Of course, the finger sensor 30 may also include circuitry embedded therein and/or in cooperation with the processor/drive circuit 23 to provide menu navigation and selection functions as will be appreciated by those skilled in the art.

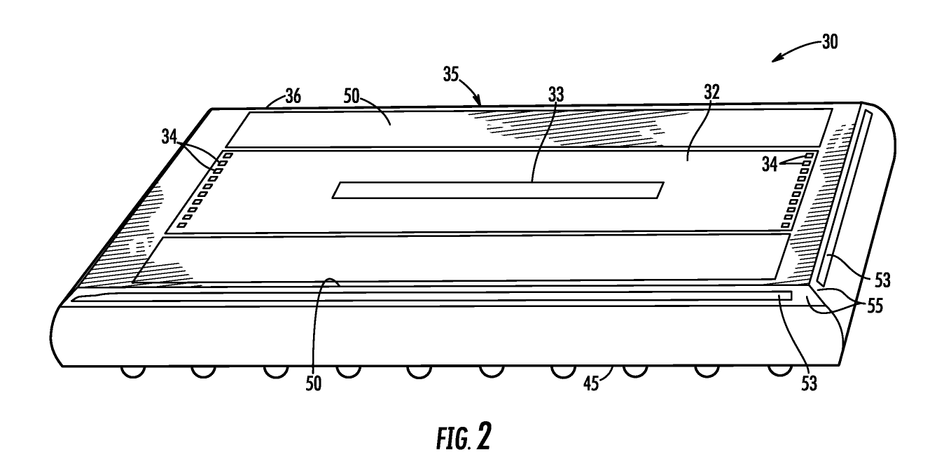

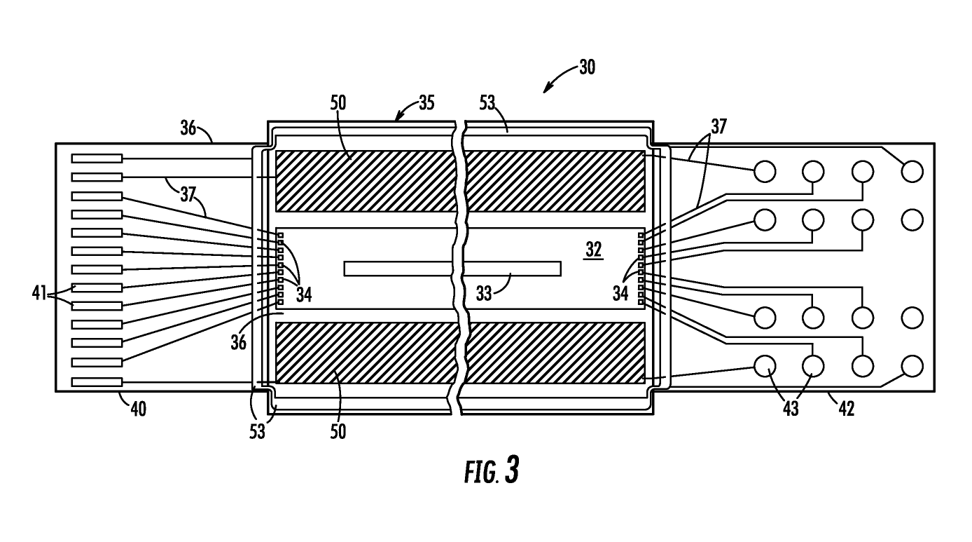

As shown perhaps best in FIGS. 2 and 3, the finger sensor 30 illustratively includes a finger sensing integrated circuit (IC) 32 including a finger sensing area 33 and a plurality of bond pads 34 adjacent thereto. In particular, the finger sensing IC 32 may include a semiconductor substrate having an upper surface, and the finger sensing area 33 may include an array of sensing electrodes carried by the upper surface of the semiconductor substrate, such as for electric field finger sensing, for example. Capacitive and/or thermal sensing pixels may also be used, for example.

The finger sensor 30 also includes a flexible circuit 35 coupled to the IC finger sensor. More particularly, the flexible circuit 35 includes a flexible layer 36 covering both the finger sensing area 33 and the bond pads 34 of the IC finger sensor 32. The flexible circuit 35 also includes conductive traces 37 carried by the flexible layer 36 and coupled to the bond pads 34. Of course, the flexible layer 36 preferably includes a material or combination of materials to permit finger sensing therethrough. Kapton is one such suitable material, although those of skill in the art will readily recognize other suitable materials. Kapton is also hydrophobic, providing an advantage that it may permit reading of partially wet or sweating fingers more readily, as any moisture may tend to resist smearing across the image, as will be appreciated by those skilled in the art.

As shown perhaps best in FIG. 3, the flexible circuit 35 may include one or more connector portions extending beyond the finger sensing area 33 and the bond pads 34. As shown, for example, in the left hand portion of FIG. 3, the connector portion may include a tab connector portion 40 wherein the conductive traces 37 terminate at enlarged width portions or tabs 41. With reference to the right hand side of FIG. 3, an alternative or additional connector portion may include the illustrated ball grid array connector portion 42, wherein the conductive traces 37 are terminated at bumps or balls 43, as will be appreciated by those of skill in the art.

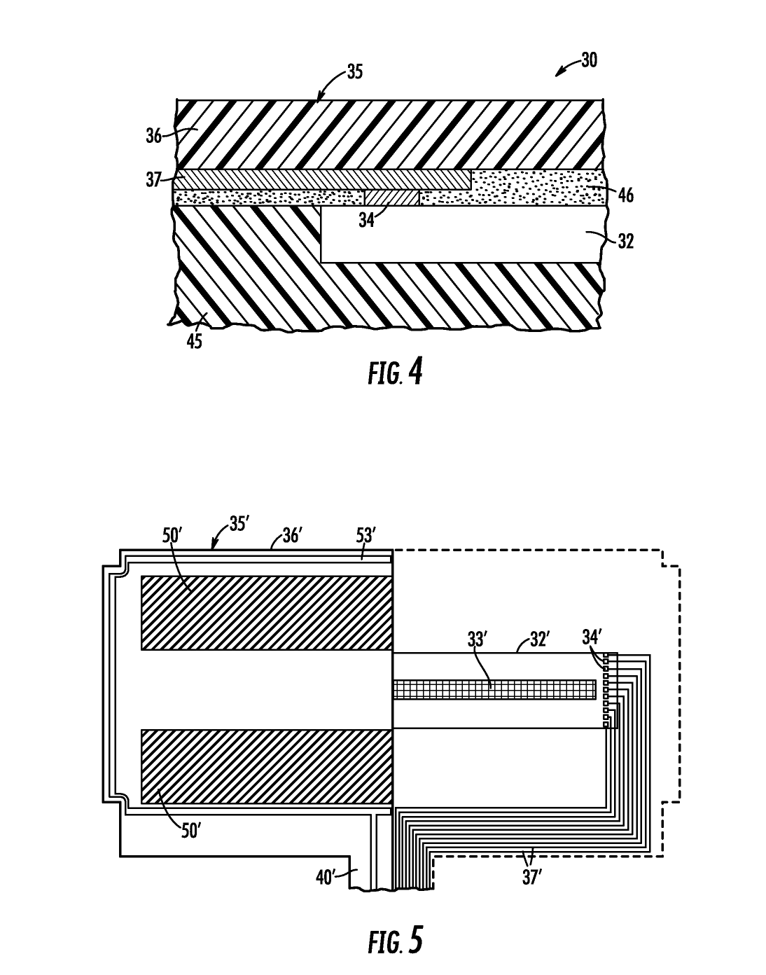

In the illustrated embodiment, the finger sensor 30 further includes an IC carrier 45 having a cavity receiving the finger sensing IC 32 therein (FIG. 4). The term IC carrier is meant to include any type of substrate or backing material on which or in which the finger sensing IC 32 is mounted. A fill material 46, such as an epoxy, is also illustratively provided between the IC finger sensor 32 and the flexible circuit 35. Accordingly, the IC finger sensor 32 may be readily coupled to external circuitry, and may also enjoy enhanced robustness to potential mechanical damage by finger or other object contact to the sensing area of the IC finger sensor.

The finger sensor 30 also includes a pair of drive electrodes 50 carried on an outer and/or inner surface of the flexible layer 36 as seen perhaps best in FIGS. 2 and 3. The drive electrodes 50 may be formed of the same conductive material as the conductive traces 37 used for the connector portions 40 or 42 as will also be appreciated by those skilled in the art. In other embodiments, only a single drive electrode 50 or more than two drive electrodes may be used. Even if the drive electrodes 50 are positioned on the inner surface of the flexible layer 36, they can still be driven with a sufficient signal strength to operate. The voltage-boosting micro transformer 25, as shown in FIG. 1, may be used, for example, to achieve the desired drive voltage on the drive electrodes 50 which may be up to about twenty volts for some embodiments.

The finger sensor 30 also includes one or more electrostatic discharge (ESD) electrodes 53 illustratively carried on the outer surface of the flexible layer 36 of the flexible circuit 35. Again the ESD electrodes 53 may be formed of a conductive material applied or deposited onto the flexible layer 36 similar to the conductive traces 37, as will be appreciated by those skilled in the art. The ESD electrodes 53 may be connected to a device ground, not shown, via one or more of the conductive traces 37.

As shown in the illustrated embodiment, the IC carrier 45 has a generally rectangular shape with four beveled upper edges 55 as perhaps best shown in FIG. 2. The beveled edges 55 are underlying or adjacent the ESD electrode 53. Of course, in other embodiments, a different number or only a single beveled edge 55 and adjacent ESD electrode 53 may be used.

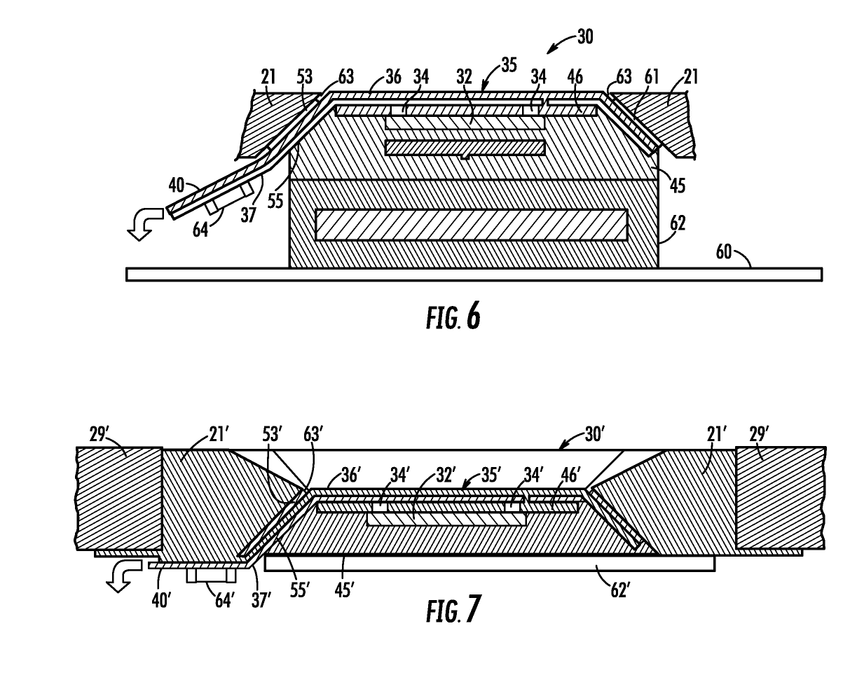

Referring now briefly to FIG. 5, another embodiment of flexible circuit 35′ suitable for the finger sensor 30 is described. In this embodiment, the tab connector portion 40′ extends from the side of the flexible layer 36′ rather from an end as shown in FIG. 3. For clarity of illustration, the right hand portion of the flexible layer 36 is not shown. Those other elements of FIG. 5 not specifically mentioned are similar to those corresponding elements described above with reference to FIG. 3 and need no further discussion herein.

Referring now additionally to FIG. 6 mounting of the finger sensor 30 is now described. In the illustrated embodiment, portions of the housing define an integral frame 21 surrounding the upper perimeter of the flexible circuit 35 that, in turn, is carried by the IC carrier 45. This positions the ESD electrodes 53 on the beveled edges of the IC carrier 45. Moreover, the integral frame 21 has inclined surfaces corresponding to the beveled edges of the IC carrier 45. This defines ESD passages 63 to the ESD electrodes 53, as will be appreciated by those skilled in the art. In other words, this packaging configuration will effectively drain off ESD through a small gap 63 between the frame and the flexible layer 36 and without having the ESD electrodes 53 directly exposed on the upper surface of the sensor 30.

The finger sensor 30 may further include at least one electronic component 64 carried by the flexible layer as also explained with reference to FIG. 6. For example, the at least one electronic component 64 may include at least one of a discrete component, a light source, a light detector, and another IC. If a light source or light detector is used, it will more likely be positioned so as to be on the upper surface of the sensor. U.S. Published Application No. 2005/0069180, assigned to the assignee of the present invention and the entire contents of which are incorporated herein by reference, discloses various infrared and optical sensors and sources that may be used in combination with the packaging features disclosed herein. Similarly, if another IC includes another finger sensing IC, for example, it would also be positioned adjacent the IC 32 on the upper surface of the IC carrier 45, as will be appreciated by those skilled in the art. For example, two or more such ICs could be positioned so that their sensing areas were able to capture images end-to-end, even if the chips themselves were staggered. Processing circuitry would stitch the images together widthwise in this example.

The mounting arrangement of FIG. 6 also illustrates another packaging aspect wherein a biasing member in the form of a body of resilient material 62, such as foam, is positioned between the illustrated device circuit board 60 and the IC carrier 45. The resilient body of material 62 permits the finger sensor 30 to be displaced downwardly or into the device to absorb shocks or blows, and causes the sensor to be resiliently pushed back into the desired alignment. The inclined surfaces of the integral frame and beveled edges 55 of the IC carrier 45 also direct the proper alignment of the sensor 30 as it is restored to its upper position, as will be appreciated by those skilled in the art.

A slightly different mounting arrangement for the finger sensor 30′ is explained with additional reference to FIG. 7, wherein a separate frame 21′ is provided that abuts adjacent housing portions 29′. The illustrated frame 21′ also sets the finger sensing IC 32′ below the level of the adjacent housing portions 29′ for additional protection. Also, the biasing member is illustratively in the form of a backing plate 62′ that is not attached on all sides and is therefore free to give and provide a returning spring force, as will be appreciated by those skilled in the art. The backing plate may carry circuit traces to thereby serves as a circuit board, as will be appreciated by those skilled in the art. Those other elements of FIG. 7 are similar to those indicated and described with reference to FIG. 6 and require no further discussion herein.

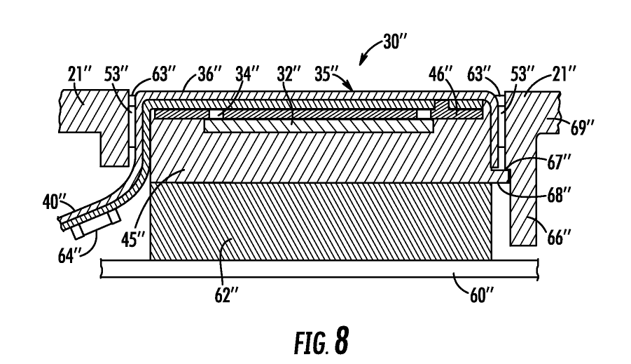

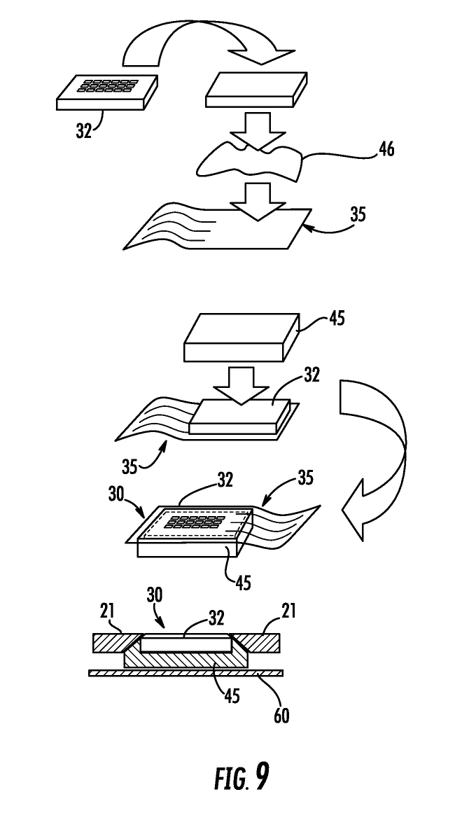

Yet another embodiment of a finger sensor 30″ is now described with reference to FIG. 8. In this embodiment, adjacent housing portions define a frame 21″ along one or more sides of the IC carrier 45″. The frame 21″ includes an upper portion 69″ and a downwardly extending guide portion 66″ offset from the upper portion that defines an interior step or shoulder 67″. This step or shoulder 67″, in turn, cooperates with the IC carrier lateral projection or tab 68″ to define an upward stop arrangement. This tab 68″ may be integrally formed with the IC carrier 45″ or include a separate piece connected to the main portion of the carrier as will be appreciated by those skilled in the art. Accordingly, the IC carrier 45″ may be deflected downwardly, and will be biased back upwardly into its desired operating position along the guide portion 66″.

The left hand portion of FIG. 8 shows an embodiment wherein the upward stop arrangement is not provided along one side to thereby readily accommodate passage of the connector portion 40″. In yet other embodiments, slots could be provided in the flexible circuit 35″ to accommodate tabs 68″ to project therethrough and provide the upward stop arrangement as well. Those of skill in the art will appreciate other configurations of stop arrangements and mounting.

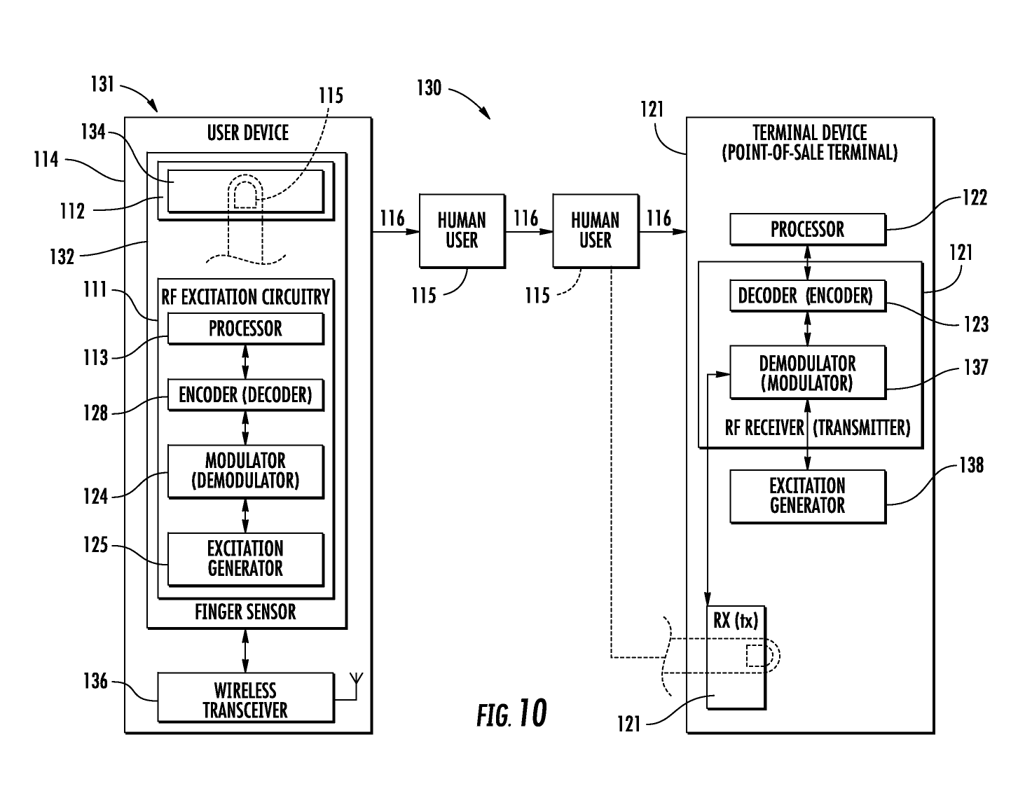

Referring now additionally to FIG. 9, a method sequence for making the finger sensor 30 is now described. Beginning at the top of the figure, the finger sensing IC 32 is flipped over and coupled to the flexible circuit 35 such as using an epoxy or other suitable fill material 46. Thereafter, as shown in the middle of the figure, the IC carrier 45 is added to the assembly which is then illustratively rotated in the upward facing position. Lastly, as shown in the lowermost portion of FIG. 8, the finger sensor 30 is mounted between the frame 21 and the underlying circuit board 60. If the ball grid array connector portion 42 (FIG. 3) is used, this portion can be wrapped and secured underneath the IC carrier 45, as will be readily appreciated by those skilled in the art. This is but one possible assembly sequence, and those of skill in the art will appreciate other similar assembly sequences as well.

The epoxy or glue 46 may be Z-axis conductive glue, and/or it may incorporate resilient energy absorbing properties. The use of an anisotropic conductive material may physically extend the pixel's effective electrical interface away from the die. The conductive material may contact the finger interface itself or it may terminate on the underside of a top protective layer of material over the sensing array. The same anisotropic conductive material may be used to electrically bond the chip's external interface bond pads 34 to conductive traces 37 on the flexible layer 36.

The IC carrier 45 may be a plastic molding or other protective material that may have resilient energy absorbing properties. It may incorporate multiple layers of different materials, or graded materials having a gradient in one or more physical properties such as stiffness. A stiff (non-stretching) but flexible material layer 36 (like Kapton) over a softer resilient material 46, all on top of the chip's surface 32, spreads the energy of a point impact across a larger area of the chip surface. The resilient material to connect the chip to the circuit board allows the chip—when under force—to move slightly with respect to the circuit board, reducing the stress on the chip. The beveled mechanical interface between the IC carrier 45 and the frame 21 allows movement in both the normal and shear directions with respect to relieve stress. The flexible circuit 35 may also include conductive patterns or traces, not shown, in the area over the sensing array to enhance the RF imaging capability.

The epoxy or glue 46 is a soft resilient layer between the stiffer flexible layer 36 and the very stiff silicon chip surface. This allows the flexible layer 36 to bend inward to reduce scratching from sharp points, and also reduce the transfer of sharp point forces to the silicon.

The IC carrier 45 and any biasing member 62 provide mechanical support to the silicon chip to prevent it from cracking when under stress, and may seal the finger sensing IC 32 and its edges from the environment. The biasing member 62 between the IC carrier 45 and the circuit board 60 can absorb shock energy in both the vertical and shear directions.

The top surface of a semiconductor chip is typically made of multiple layers of brittle silicon oxides and soft aluminum. This type of structure may be easily scratched, cracked, and otherwise damaged when force is applied to a small point on that surface. Damage typically occurs when the pressure applied to the insulating surface oxide propagates through to the aluminum interconnect material directly beneath it. The aluminum deforms removing support from under the oxide, which then bends and cracks. If sufficient force is applied this process may continue through several alternating layers of silicon oxide and aluminum, short-circuiting the aluminum interconnects and degrading the chip's functionality.

In the package embodiments described herein, a sharp object approaching the sensor first contacts the substrate layer (typically Kapton tape). The substrate material deforms and presses into the resilient glue material, spreading the force over a larger area and reducing the maximum force per area transmitted. The spread and diluted force transmitted through the resilient glue now causes the chip to move downward away from the impacting object and into the resilient backing material. Some of the impact energy is converting into motion of the chip and ultimately into compression of the resilient backing material. Finally, when the chip is forced downward into the resilient backing, the chip will often tilt—encouraging the sharp object to deflect off the sensor. The stiffness of the various layers of resilient material are selected to protect the aluminum interconnects in the silicon chip against the most force possible.

The packaging concepts discussed above make a package that is: durable enough for use on the external surfaces of portable electronic equipment; and maintains good sensing signal propagation, resulting in good quality sensor data. The embodiments are relatively inexpensive and straightforward to manufacture in high volume.

Now reviewing a number of the possible advantages and features of the finger sensors disclosed herein, significant improvements in scratch resistance can be achieved by combining a surface material like Kapton that is relatively stiff and difficult to tear, with a softer glue material underneath. With this structure, when a sharply pointed object comes into contact, the surface material can indent, reducing the initial impact, spreading the force across a larger area, and preventing the point from penetrating the surface. When the object is removed, the resilient materials return to their original shapes.

A flexible substrate with a smooth surface and a low coefficient of friction (such as a Kapton tape) will help resist abrasion. The resilient structure described above can also improve abrasion resistance by preventing the abrasive particles from cutting into the surface. The resilient structure described above also provides several levels of protection against impacts of various intensities.

When a portable device like a cellular telephone is dropped, a shearing force is applied to any structure that interconnects the case with the internal circuit boards. In a sensor that is soldered to the internal circuit board and projects through a hole in the case, the full shearing force is applied to the sensor and its circuit board interconnects. In the package described above, the shear force is absorbed by the resilient material that may mechanically connect the sensor to the circuit board. If the shear force is extreme, the beveled sensor will slip under the case, converting the shear force into normal compression of the resilient backing material. When the impact event is over the sensor will return to its normal position.

The package described can also provide protection against continuous pressure. When pressure is applied, the resilient backing compresses, allowing the sensor to retract from the surface a small distance. In many situations this will allow the case to carry more of the force, reducing the force on the sensor.

In the packaging described herein, the flexible substrate material also acts as an electrostatic discharge (ESD) barrier between the chip and its environment, preventing ESD from reaching the sensitive electronic devices on the chip. Accordingly, leakage current tingle may be significantly reduced or eliminated. A 1 mil Kapton layer provides an 8.6 Kv withstand capability. The ESD electrodes can capture discharges at higher voltages. The maximum voltage over the drive electrodes prior to air breakdown to the ESD electrode is 7.5 Kv. The distance from the farthest point of the drive electrode to the ESD capture electrodes is 2.5 mm, and the dry air dielectric breakdown is 3 Kv/mm. Accordingly, even with a clean surface (worst case) the ESD would discharge to the ESD capture electrode before penetrating the Kapton dielectric layer. In addition, over the array is provided 1 mil of Kaptom, plus 1 mil of epoxy, plus 2.5 microns of SiN. This may provide about 14.1 Kv dielectric withstand over the pixel array. This may eliminate a requirement for outboard ESD suppressors and associated circuitry.

Some mechanical durability data is provided below in TABLE 1. In particular, three devices are compared: a model 1510 small slide IC with a nitride coating and no adhesive, a 1510° C. with a polyimide coating and no adhesive, and a model 2501 large slide IC with a Kapton layer and acrylic adhesive/filler. The drill rod scratch and pencil scratch tests are ANSI tests. The other three tests are self-explanatory, and it can be seen that the Kapton/filler device enjoys a considerable advantage in terms of mechanical robustness.

TABLE 1

| | Bare | 7 μm | 25 μm |
|---|---|---|---|
| Substrate | Nitride | Polyimide | Kapton |
| Adhesive | N/A | N/A | Acrylic |
| Test Die | 1510 | 1510 | 2501 Ni |
| Drill Rod Scratch (grams) | <50 | 225 | 350 |
| Pencil Scratch (hardness) (5) | N/A | HB | 6H |
| 6.5 mm Ball Impact (gr cm) | 234 | 234 | 488 |
| 1.0 mm Ball Impact (gr cm) | <75 | <13 | 195 |
| Rock Tumbler (hrs) | N/A | <8 | 67 |

All or part of the desired circuitry may be included and mounted on the flexible circuit. The customer interface could then be a simple standard interface, such as a USB connector interface. LEDs can be included on the flexible circuit, or electroluminescent sources can be added as printed films. Organic LEDs can be printed as films on the underside of the flexible circuit.

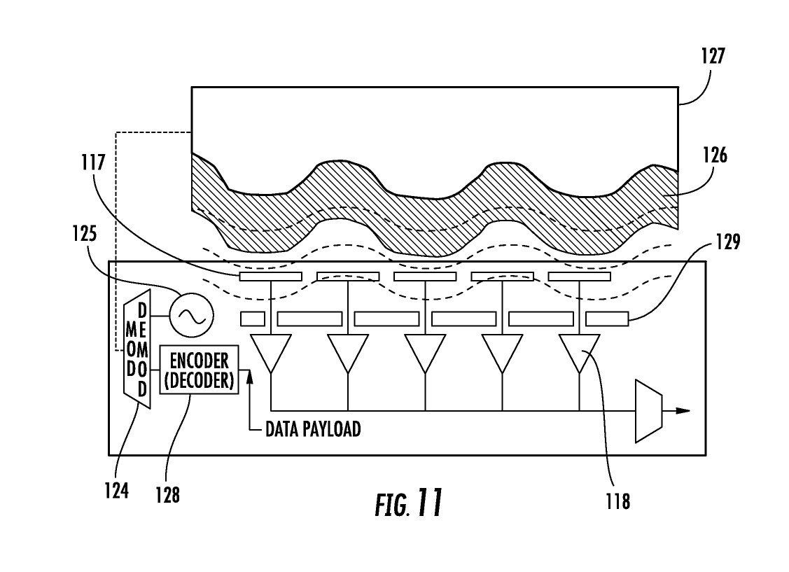

Referring now additionally to FIGS. 10 and 11, another embodiment of a finger sensor 132 and its use in a user device 131 are now described. The user device may be a telephone, for example, similar to the cellular telephone 20 in FIG. 1, a personal computer, PDA, or other portable device, for example. The user device 131 includes a portable housing 114 and a finger sensor 132 coupled thereto. The user device 131 may also include a wireless transceiver 136 carried by the portable housing 114 for performing a wireless communications function, for example, cellular communications.

The finger sensor 132 may be a fingerprint sensor and may include any of the various sensor embodiments described above with reference to FIGS. 1-9, or any other similar finger sensor as will be appreciated by those skilled in the art.

The finger sensor 132 illustratively includes RF excitation circuitry 111 and a drive ring 112 coupled thereto. This circuitry may be fully implemented on the finger sensing IC as described, or may be implemented entirely off the finger sensing chip, or some combination thereof.

The RF excitation circuitry 111 illustratively includes the host processor 113 to deliver a data payload to the data encoder 128. As will be appreciated by those skilled in the art, data encoding may be particularly advantageous for error checking and compression, for example. The data payload may include data for purchase transactions, information exchanges, and identity validations, for example. Of course, other types of data for other data transactions will be appreciated by those skilled in the art. A modulator 124 combines the data payload with the excitation signal output from the excitation generator 125. The modulator 124 uses the excitation signal output from the excitation generator 125 as a carrier signal and modulates the data payload onto the carrier signal. Various modulation and/or encoding schemes may be used, such as simple ON/OFF keying, for example. An excitation signal reference plane 129 illustratively is positioned between the pixel antenna array 117 and the sense amplifiers 118 to provide a ground plane for the excitation signal. The combined RF data signal 116 is driven through the human user's 115 finger skin via the drive ring 112, which is illustratively included along the outer perimeter of the finger sensing area 134. Alternatively, the drive electrodes 50, as described above, can be used to pass the RF data signal 116 to and from the user 115.

The RF excitation circuitry 111 applies a field to the highly conductive sub surface layer of a user's skin, as illustrated best in FIG. 11. As will be appreciated by those skilled in the art, a user's skin includes an outer dielectric skin layer 126 that is illustratively in contact with the surface of the finger sensor 132. The user's skin also includes a live skin cell layer 127 that provides a conduit for the RF data signal 116.

Indeed, to provide data transactions for purchasing, information exchange, and identity validation, for example, the transaction should be perceived by the user as being secure. For added security, the drive ring 112 and associated RF excitation circuitry 111 may not be activated to send the RF data signal 116 unless there has been authentication of the user via the finger sensor 132. In other words, the sensing area 134, as described above, is also used for authentication, for example, authentication based upon a finger biometric. Of course, the finger sensor 132 may include other biometric sensors for authentication, as described in U.S. Pat. No. 7,358,514, the entire contents of which are herein incorporated by reference.

Alternatively or additionally, the finger sensing area 134 may be used for a user device 131 navigation function, for example, navigating a menu on the user device. The RF excitation circuitry 111 may be activated to send the RF data signal 116 based upon a navigation sequence from the user via the finger sensor 132.

Advantageously, the human body or human user 115 serves as a transfer medium for the data signal 116. The RF data signal 116 is received when the user touches a conductive RF terminal receiver 121 of the terminal device 120 and thereby completes the circuit to transfer data. Thus, the data transaction is fast, which is especially beneficial for retailers of this technology, and it appears to be convenient and near effortless to a user 115.

The conductive RF terminal receiver 121 includes signal RF terminal demodulator circuitry 137 for demodulating the RF data signal 116. The demodulated RF data signal is also decoded by RF terminal signal decoder circuitry 123, if the RF data signal is encoded, for example, by the encoder 128 of the user device 131. The RF data signal 116 is processed by the processor 122, which is coupled to the decoder circuitry 123 and the demodulator circuitry 137 in the conductive RF terminal receiver 121. The terminal device 120 may be a point of sale (POS) receiver or another mobile wireless communications device, for example. Other receivers will be appreciated by those skilled in the art.

Still further, it should be noted that the communications system 130 may be bi-directional. In other words, the terminal device 120 may also include circuitry to transmit another RF data signal (not shown) through the user 115 to the user device 131. More particularly, the conductive RF terminal receiver 121 may include additional circuitry so that it also operates as a conductive RF terminal transmitter. As will be appreciated by those skilled in the art, the decoder circuitry 123 and the demodulator circuitry 137 of the conductive RF terminal receiver 121, may also operate as an encoder and modulator respectively in a half-duplex mode for both receiving and transmitting. An RF terminal excitation generator 138 may provide the carrier signal. The RF terminal encoder circuitry 123 and the RF terminal modulator circuitry 137 cooperate with the processor 122 to encode and modulate the another RF data signal. For example, data relating to a transaction, such as an order confirmation, may be encoded and transmitted.

The RF excitation circuitry 111 of the user device 131 may also serve as a conductive RF device user receiver to receive the RF data signal transmitted from the terminal device 120. The RF excitation circuitry 111 components, for example, the encoder 128 and the modulator 124, may also operate as a decoder and a demodulator, respectively, in a half-duplex mode also for receiving, for example. Other components for receiving the RF data signal may be included, as will be appreciated by those skilled in the art. Moreover, as will be appreciated, while some components for receiving may also be configured for transmitting and vice versa, additional or separate components may be provided for each of the transmit and receive functions.

The RF data signal 116 may also be transferred to another human 115′ via a handshake, for example, as is the case in an information or business card exchange. The other human 115′ may have a conductive terminal RF receiver 121 on his body or may also be touching a finger sensor 132 for added security in completing the transaction. Accordingly, transactions can be completed quickly with a touch of a finger and with high security.

In other embodiments, a method for communicating may include authenticating a user with a finger sensor 132. Upon authentication, RF excitation circuitry 111 serves as a conductive RF user device transmitter and drives a data signal 116 to a drive ring 112 of the finger sensor. Alternatively or additionally, the RF excitation circuitry 111 may serve as a conductive RF user device transmitter and drives a data signal 116 to a drive ring 112 of the finger sensor based upon a user navigation function.

The method includes transmitting the data signal 116 onto the human user's 115 finger into the user's body. The RF data signal 116 is received by a terminal RF receiver 121 when the user 115 touches the terminal RF receiver with another finger, hand, or other body part, to thereby complete the circuit. In some embodiments, the RF excitation circuitry 111 is also for serving as a conductive RF user device receiver to receive the RF signal from the user 115 and transmitted from the RF transmitter 137 of the terminal device 120.

Still, in other embodiments, a method for providing a communications system 130 may include providing a finger sensor 132 in a user device 131. The finger sensor 132 includes RF excitation circuitry 111 and a drive ring 112 coupled thereto to drive an RF data signal 116 through a human user's 115 skin when coupled to the fingerprint sensor assembly. The method also includes providing a conductive RF terminal receiver 121 in a terminal device 120 to receive the RF data signal 116 driven into the user's skin 115. The method may also include providing a human 115 to couple the finger sensor 132 to the conductive RF terminal receiver 121 and provide a conduit for the RF data signal 116.

As will be appreciated by those skilled in the art, contact as described herein, for example, between the user 115 and the conductive RF receiver 121 may include contact with an intervening dielectric layer between the user's outer dielectric skin layer 126 and the drive electrode 50 or drive ring 112, as the signal is an RF signal. In other words, the RF signal may be transmitted onto the user 115 without absolute contact as long as there is sufficient drive power.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included as readily appreciated by those skilled in the art.

That which is claimed is:

1. A communications system comprising:
a terminal device comprising
a housing, and
a conductive radio frequency (RF) terminal receiver carried by said housing for receiving an RF signal conducted via contact with a user; and
a user device comprising
a portable housing, and
a finger sensor carried by said portable housing and comprising radio frequency (RF) excitation circuitry for sensing a finger of the user, said RF excitation circuitry also for serving as a conductive RF user device transmitter to transmit the RF signal onto the user to be received by said conductive RF terminal receiver.

2. The communications system according to claim 1, wherein said RF excitation circuitry is for performing a user authentication function.

3. The communications system according to claim 2, wherein said RF excitation circuitry transmits the RF signal onto the user based upon a successful user authentication.

4. The communications system according to claim 1, wherein said RF excitation circuitry is for performing a device navigation function.

5. The communications system according to claim 1, wherein said user device further comprises a wireless transceiver carried by said portable housing.

6. The communications system according to claim 1, wherein said RF excitation circuitry is also for serving as a conductive RF user device receiver for receiving an RF signal from the user.

7. The communications system according to claim 1, wherein said finger sensor further comprises a drive electrode coupled to said RF excitation circuitry to transmit the RF signal onto the finger of the user.

8. The communications system according to claim 1, wherein said terminal device comprises a point-of-sale (POS) terminal device.

9. A user device comprising:
a portable housing; and
a finger sensor carried by said portable housing and comprising radio frequency (RF) excitation circuitry for sensing a finger of a user, said RF excitation circuitry also for serving as a conductive RF user device transmitter to transmit the RF signal onto the user.

10. The user device according to claim 9, wherein said RF excitation circuitry is for performing a user authentication function.

11. The user device according to claim 10, wherein said RF excitation circuitry transmits the RF signal onto the user based upon a successful user authentication.

12. The user device according to claim 9, wherein said RF excitation circuitry is for performing a device navigation function.

13. The user device according to claim 9, further comprising a wireless transceiver carried by said portable housing.

14. The user device according to claim 9, wherein said RF excitation circuitry is also for serving as a conductive RF user device receiver for receiving an RF signal from the user.

15. A communications system comprising:
a conductive radio frequency (RF) receiver for receiving an RF signal conducted via contact with a user; and
a user device comprising
a portable housing, and
a finger sensor carried by said portable housing and comprising radio frequency (RF) excitation circuitry for sensing a finger of the user, for performing a user authentication function, and for serving as a conductive RF transmitter to transmit the RF signal onto the user to be received by said conductive RF receiver.

16. The communications system according to claim 15, wherein said RF excitation circuitry transmits the RF signal onto the user based upon a successful user authentication.

17. The communications system according to claim 15, wherein said user device further comprises a wireless transceiver carried by said portable housing.

18. The communications system according to claim 15, wherein said RF excitation circuitry is also for serving as a conductive RF user device receiver for receiving an RF signal from the user.

19. The communications system according to claim 15, wherein said finger sensor further comprises a drive electrode coupled to said RF excitation circuitry to transmit the RF signal onto the finger of the user.

20. A communications system comprising:
a conductive radio frequency (RF) receiver carried by said housing for receiving an RF signal conducted via contact with a user; and
a user device comprising
a portable housing, and
a finger sensor carried by said portable housing and comprising radio frequency (RF) excitation circuitry for sensing a finger of the user, for performing a device navigation function, and for serving as a conductive RF transmitter to transmit the RF signal onto the user to be received by said conductive RF receiver.

21. The communications system according to claim 20, wherein said user device further comprises a wireless transceiver carried by said portable housing.

22. The communications system according to claim 20, wherein said finger sensor further comprises a drive electrode coupled to said RF excitation circuitry to transmit the RF signal onto the finger of the user.

23. The communications system according to claim 20, wherein said RF excitation circuitry is also for serving as a conductive RF user device receiver for receiving an RF signal from the user.

24. A method for communicating comprising:
using RF excitation circuitry of a user device for sensing a finger of the user; using the RF excitation circuitry for serving as a conductive RF transmitter to transmit the RF signal onto the user.

25. The method according to claim 24, further comprising receiving the RF signal from an RF receiver of a terminal device via contact with the user.

26. The method according to claim 24, wherein further comprising performing a user authentication function using the RF excitation circuitry.

27. The method according to claim 26, wherein transmitting the RF signal onto the user based is based upon a successful user authentication.

28. The method according to claim 24, further comprising performing a device navigation function using the RF excitation circuitry.

29. The method according to claim 24, further comprising transmitting another RF signal onto the user from the terminal device to be received by the user device.

30. The method according to claim 24, wherein the terminal device comprises a point-of-sale (POS) terminal device.
